(19) United States
(12) Patent Application Publication
(10) Pub. No.: US 2002/0114399 A1
(43) Pub. Date: Aug. 22, 2002

(54) Method and apparatus for bit-wise synchronous decoding of serial communication data

(76) Inventors: Hamid Reza Piroozi, Noblesville, IN (US); Jerry William Campbell, Carmel, IN (US)

Correspondence Address: JIMMY L. FUNKE, DELPHI TECHNOLOGIES, INC., Legal Staff Mail Code A-107, P. O. Box 9005, Kokomo, IN, 46904-9005, US

(21) Appl. No.: 09/804,638

(22) Filed: Feb. 16, 2001

(51) Int. Cl. H04B 3/00; H04L 25/00; H04L 25/34

(52) U.S. Cl. 375/257; 375/286; 375/369

(57) ABSTRACT

An improved method and apparatus for decoding serial data uses a bit-wise synchronization technique in which a single bi-directional counter integrates the value of each successive bit to decode the bit state. The counter is sized relative to the receiver module oscillator frequency and the minimum data transmission speed to prevent overflow under worst case conditions, and the count is reset to one-half the maximum count at the beginning of each bit. During the bit period, oscillator clock pulses respectively increase or decrease the count when the bit value is above or below a threshold, and the bit value is determined in accordance with the most significant bit of the counter at the end of the respective bit period. Only a single counter is used to decode the data, and the data is substantially insensitive to noise because filtering can be used to reliably establish the state boundaries of the data bits.

### TECHNICAL FIELD

This invention relates to the reception of serial communication data, and more particularly to a method and apparatus for efficiently decoding serial communication data through bit-wise synchronization of a local oscillator.

### BACKGROUND OF THE INVENTION

In most serial communication systems, data is transmitted from one module to another as a series of bits grouped into frames of variable duration. The logic state of the individual bits encodes the data as a pattern of one and zero logic levels, and the receiving module includes a high frequency oscillator that supplies clock pulses to one or more bit time counters for determining when to sample the data. Synchronizing the various oscillators can ensure accurate communication, but this approach is frequently avoided to minimize system cost. If the oscillators operate asynchronously, they must be very accurate; and if the speed of data transmission is variable, some mechanism must be provided for indicating the transmission speed to the receiver module. A particularly advantageous technique (commonly referred to as bit-wise synchronization) for achieving reliable serial data communication at variable transmission speed is to re-synchronize the bit time counters at the beginning of each bit, and to include a “dummy” bit at the beginning of each data frame for defining the bit period (transmission speed) used in the data frame. In this technique, a bit period counter is used to measure the width of the dummy bit, and the bit value (logic state) is sampled when the bit time counter reaches a predetermined percentage (such as 50%) of the measured bit period for the data frame. In addition to requiring two different counters at each data receiver, the bit-wise synchronization technique is subject to communication error in noisy environments because the bit value may be sampled during a noise pulse. Accordingly, what is needed is a bit-wise synchronization technique that is more accurate in the presence of noise, and that reduces the receiver module circuitry requirements.

### SUMMARY OF THE INVENTION

The present invention is directed to an improved method and apparatus for decoding serial data using a bit-wise synchronization technique, in which a single bi-directional counter is used to integrate the value of each successive bit to decode the bit state. The counter is sized relative to the receiver module oscillator frequency and the minimum data transmission speed to prevent overflow under worst case conditions, and the count is reset to one-half the maximum count at the beginning of each bit. During the bit period, oscillator clock pulses respectively increase or decrease the count when the bit value is above or below a threshold, and the bit value is determined in accordance with the most significant bit of the counter at the end of the respective bit period. Only a single counter is used to decode the data, and the data is substantially insensitive to noise because the counter integrates many samples to determine the bit value, and filtering can be used to reliably establish the state boundaries of the data bits.

### BRIEF DESCRIPTION OF THE DRAWINGS

The above and other advantages of the invention will become more apparent from the following description taken in conjunction with the accompanying drawings wherein like references refer to like parts and wherein:

FIG. 1 is a graph depicting received serial communication data with respect to time.

FIG. 2 is block diagram of a circuit for decoding the serial communication data of FIG. 1 according to this invention.

### DESCRIPTION OF THE PREFERRED EMBODIMENT

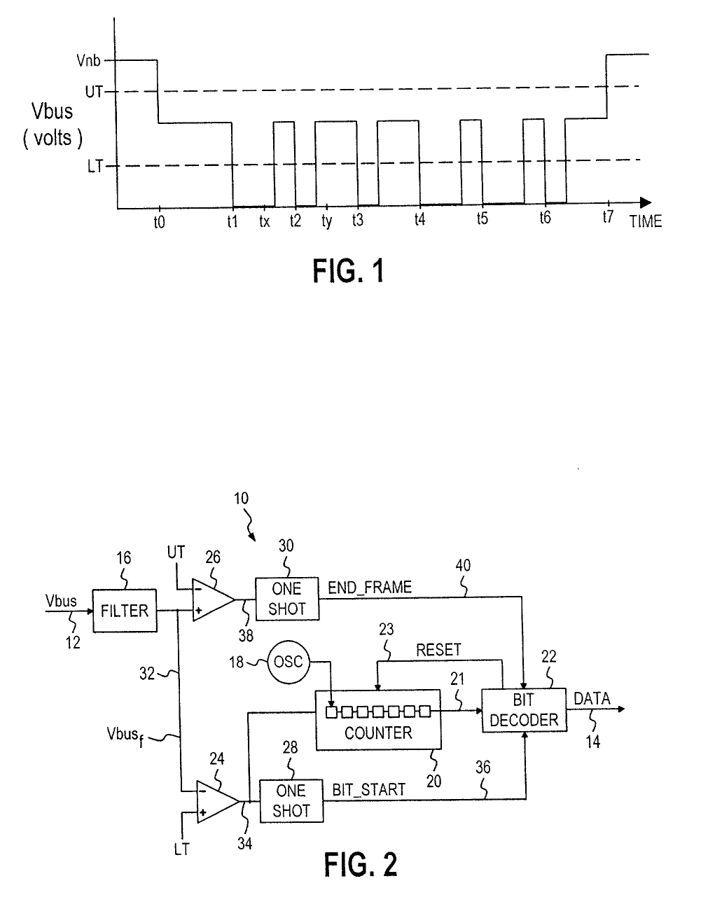

The present invention is described herein in the context of the serial data communication scheme graphically depicted in FIG. 1, where the bus voltage Vbus is shown as a function of time. The bus voltage Vbus has a nominal value Vnb that exceeds an upper threshold UT when no data is being communicated. During data communication, Vbus falls below upper threshold UT, and the falling edge at time t0 signals the start of a data frame consisting of a dummy bit and multiple data bits. The dummy bit has a value that lies between the upper threshold UT and a lower threshold LT, and defines the period of each data bit in the frame. The ensuing data bits, on the other hand, have an initial value that is below lower threshold LT, and represents a logic zero. Thus, the duration of the data bits is defined by the time difference (t1−t0). In FIG. 1, the first data bit occurs in the interval t1-t2, the second data bit in the interval t2-t3, and so on.

In the illustrated embodiment, the logic state the data is encoded by duty cycle modulation of the respective data bits. Specifically, each data bit is divided into thirds, and the bit value changes from a logic zero (a value less than LT) to a logic one (a value between LT and UT) at either the one-third mark or the two-thirds mark. The encoded data has a value of zero if the bit value is below LT for ⅔ of its period, and a value of one if the bit value is between LT and UT for ⅔ of its period. Thus, the data represented in the exemplary data frame of FIG. 1 is 011001. Of course, other data communication schemes could be utilized, but the described scheme is particularly advantageous because it includes a recognizable logic transition at the initiation of each bit, which permits re-synchronization of each bit.

A conventional technique for decoding data that has been encoded as described above is to sample the bit value at its midpoint. For example, the receiver oscillator clocks a bit period counter to measure the duration of the dummy bit, a bit time counter also clocked by the receiver oscillator is reset at the beginning of each bit (that is, at each logic one-to-logic zero transition of the data frame), and the bit value is sampled whenever the bit time counter reaches one-half the measured bit period. If the encoded data has a value of zero, the sampled bit value will have a zero logic value (as indicated in FIG. 1 by the time tx); if the encoded data has a value of one, the sampled bit value will have a one logic value (as indicated in FIG. 1 by the time ty). As indicated above, a shortcoming of this technique is that the data may be incorrectly decoded if bus voltage noise occurs when the bit value is sampled.

In contrast to the technique described in the preceding paragraph, the present invention relates to a decoding technique that requires only a single counter, and that is less susceptible to decoding errors due to bus voltage noise. According to the invention, the dummy bit is ignored (and may be omitted), and a single bi-directional counter is used to integrate multiple samples of each data bit to decode the corresponding data. The counter is sized relative to the receiver module oscillator frequency and the minimum data transmission speed to prevent overflow under worst case conditions, and the count is reset to one-half the maximum count at the beginning of each data bit. During the bit period, oscillator clock pulses respectively increase or decrease the count when the bit value is above or below lower threshold LT, and the data value is determined according to the most significant bit of the counter at the end of the respective data bit. The decoded data is substantially insensitive to bus voltage noise because the counter integrates many samples to determine the bit value, and filtering is used to reliably establish the data bit logic states.

Referring to FIG. 2, the reference numeral 10 generally designates a decoder circuit according to this invention. The bus voltage Vbus is applied to the circuit 10 on line 12, and the circuit 10 outputs the decoded data on line 14. The circuit 10 comprises a low-pass filter 16 to attenuate high frequency noise in bus voltage Vbus, an oscillator 18, a bi-directional (up/down) counter 20, a bit decoder 22, and a pair of comparators 24, 26 and one-shots 28, 30 for establishing the counter direction and triggering the bit decoder 22. The filtered bus voltage Vbus_{f} appears on line 32 and is applied to comparators 24 and 26. Comparator 24 compares Vbus_{f} to lower threshold LT, generating a zero-to-one logic transition on line 34 at the beginning of each data bit (that is, at times t1, t2, t3, t4, t5 and t6 in FIG. 1), and a one-to-zero logic transition when the logic value of each data bit changes from zero to one. The line 34 is applied to the count direction input (U/D) of counter 20 so that clock pulses provided by oscillator 18 clock the counter value in opposite directions depending on the logic value of the data bits. In the illustrated embodiment, for example, the clock pulses decrease the counter value when the logic value of the data bits is zero and increase the counter value when the logic value of the data bits is one. The one-shot 28 generates a clock pulse on BIT_START line 36 at each zero-to-one logic transition of comparator 24 on line 34, signaling bit decoder 22 to sample the most significant bit of counter 20 on line 21 and then to reset counter 20 via RESET line 23 to one-half the maximum (overflow) value of counter 20. If the sampled counter bit is greater than the counter reset value, the data value for the preceding data bit is a logic one; if the sampled counter bit is less than the counter reset value, the data value for the preceding data bit is a logic zero. In this scheme, the first BIT_START clock pulse in each data frame does not correspond to a data bit, and is ignored or not outputted on line 14. Thus, the counter value at time t2 indicates the value of the first data bit, the counter value at time t3 indicates the value of the second data bit, and so on. Comparator 26 and one-shot 30 detect the end of the data frame for purposes of signaling the bit decoder to sample a counter value corresponding to the last data bit of the data frame. Specifically, comparator 26 compares Vbus_{f} to upper threshold UT, generating a zero-to-one logic transition on line 38 at the end of the data frame (that is, at time t7 in FIG. 1), and one-shot 30 generates a clock pulse on END_FRAME line 40 at each zero-to-one logic transition of comparator 24, signaling bit decoder 22 to sample the most significant bit of counter 20, as explained above.

In summary, the present invention provides a low-cost and noise tolerant technique for achieving bit-wise synchronous data decoding in a serial data communication system. The need for a dummy pulse is eliminated, and the bi-directional counter effectively integrates multiple samples of the bus voltage to reliably indicate the value of a duty-cycle modulated data bit. While the invention has been described in reference to the illustrated embodiment, it is expected that various modifications in addition to those mentioned above will occur to those skilled in the art. For example, some or all of the above-described functionality of the decoder circuit may be carried out with a programmed microprocessor. Alternately, the counter, one shots and bit decoder may be implemented in digital finite state machine architecture. The filter 16 could be implemented digitally as well. Accordingly, it will be understood that methods and circuits incorporating such modifications may fall within the scope of this invention, which is defined by the appended claims.

1. A method of decoding serially received data bits encoded on a bus voltage as a pattern of first and second logic levels, the method comprising the steps of:
identifying a start and an end of each data bit;
initializing a counter value to a starting value when the start of a data bit is identified;
detecting the logic level of the bus voltage;
incrementing the counter value at a predefined rate so long as the detected logic level is the first logic level;
decrementing the counter value at a predefined rate so long as the detected logic level is the second logic level; and
when the end of the data bit is identified, comparing the counter value to the starting value to decode the logic level of the data bit.

2. The method of claim 1, wherein the data bits are encoded as a first logic level period followed by a second logic level period, with the first logic level period exceeding the second logic level period for a data bit of the first logic level, and the second logic level period exceeding the first logic level period for a data bit of the second logic level, including the steps of:
decoding the logic level of the data bit as the first logic level when the counter value is above the starting value; and
decoding the logic level of the data bit as the second logic level when the counter value is below the starting value.

3. The method of claim 1, wherein the step of identifying the start and end of each data bit includes the step of:
low-pass filtering the bus voltage; and
comparing the filtered bus voltage to a voltage threshold intermediate first and second reference voltages corresponding to the first and second logic levels.

4. Apparatus for decoding serially received data bits encoded on a bus voltage as a pattern of first and second logic levels, comprising:
an oscillator producing clock pulses at a fixed clock frequency;
a bi-directional counter for counting the clock pulses of said oscillator;
initialization means for initializing said bi-directional counter to a starting value at a start of each data bit;
direction control means for configuring the counter to count the clock pulses in a first direction so long as the bus voltage is at said first logic level, and to count the clock pulses in a second direction so long as the bus voltage is at said second logic level; and
a bit decoder for sampling a count of said counter at an end of the data bit and decoding the logic level of the data bit by comparing the sampled count to the starting value.

5. The apparatus of claim 4, wherein the data bits are encoded at a transmission frequency that is at least as great as a minimum transmission frequency, the starting value is substantially one-half of a maximum count of the counter, and said maximum count is sufficiently large to prevent an overflow of said counter when the data bits are encoded at said minimum transmission frequency.

6. The apparatus of claim 4, wherein the data bits are encoded as a first logic level period followed by a second logic level period, with the first logic level period exceeding the second logic level period for a data bit of the first logic level, and the second logic level period exceeding the first logic level period for a data bit of the second logic level, and wherein:
said bit decoder decodes the logic level of the data bit as the first logic level when the sampled count exceeds the starting value; and
said bit decoder decodes the logic level of the data bit as the second logic level when the starting value exceeds the sampled count.

7. The apparatus of claim 4, wherein said direction control means comprises:
a low-pass filter for filtering noise out of the bus voltage; and
a comparator for comparing the filtered bus voltage to a voltage threshold intermediate first and second reference voltages corresponding to the first and second logic levels.
